(19) United States
(12) Patent Application Publication
(10) Pub. No.: US 2015/0159052 A1
(43) Pub. Date: Jun. 11, 2015

(54) LIGHT-ABSORBING HEAT-ACTIVABLE ADHESIVE COMPOUND AND ADHESIVE TAPE CONTAINING SUCH ADHESIVE COMPOUND

(71) Applicant: TESA SE, Hamburg (DE)

(72) Inventor: Roger Teng, Jiangsu (CN)

(21) Appl. No.: 14/400,966

(22) PCT Filed: May 7, 2013
(86) PCT No.: PCT/EP2013/059508

§ 371 Date: Nov. 13, 2014

(30) Foreign Application Priority Data
May 21, 2012 (DE) 20 2012 004 946.1

(51) Int. Cl. C09J 7/02; C09J 11/04

(52) U.S. Cl. CPC C09J 7/0203; C09J 7/0285; C09J 11/04; C09J 2415/00; C09J 2461/00; C09J 2467/006; C09J 115/00

(57) ABSTRACT

Adhesive film comprising at least one carrier film and two external adhesive compound layers, at least one of the adhesive compounds being a heat-activable bondable adhesive compound, with black pigments added to the heat-activable adhesive compound.

This is a 371 of PCT/EP2013/059508 filed 7 May 2013, which claims foreign priority benefit under 35 U.S.C. 119 of German Patent Application 20 2012 004 946.1 filed 21 May 2012, the entire contents of which are incorporated herein by reference.

### BACKGROUND OF THE INVENTION

The invention relates to black-colored heat-activable adhesive compositions, in particular for use for an adhesive film for adhesively bonding metal parts onto plastics in portable electronic consumer articles, and also adhesive tape structures comprising adhesive films made from black heat-activable adhesive compositions.

Double-sided pressure-sensitive adhesive tapes are usually employed for adhesive bonding of metal parts onto plastics. The adhesive forces required for this purpose are sufficient to fix and fasten the metal components on the plastics. As metals, preference is given to using steel, stainless steel and aluminum. Plastics used are, for example, PVC, ABS, PC and blends based on these plastics. However, the demands made for portable electronic consumer articles are continually increasing. These articles are becoming ever smaller, so that the adhesive bonding areas are also becoming smaller. These prerequisites are particularly problematical for adhesive bonding of metals onto plastics. This can be achieved in a particularly efficient way by the use of heat-activable films which can form a particularly high adhesive force after activation.

Heat-activable adhesive compositions which are also suitable as matrix for the adhesive film of the invention can in principle be divided into two categories, namely thermoplastic heat-activable adhesive compositions and reactive heat-activable adhesive compositions.

### a) Thermoplastic Heat-Activable Adhesive Compositions

These adhesive compositions display no or little self-adhesion at room temperature. The adhesive composition only becomes activated and self-adhesive when exposed to heat. A high glass transition temperature of the adhesive composition is responsible for this, so that the activation temperature for achieving sufficient stickiness is generally from a few to one hundred degrees Celsius above room temperature. Owing to the self-adhesive properties, an adhesive effect occurs even before setting of the composition. After the parts to be adhesively bonded are placed together, the thermoplastic heat-activable adhesive composition sets physically (use of suitable thermoplastic materials as adhesive composition; which generally results in reversible adhesive bonding), optionally additionally chemically (use of suitable thermoplastic reactive materials as adhesive composition, which generally results in irreversible adhesive bonding) on cooling with solidification, so that the adhesive effect is maintained in the cooled state and the actual adhesive forces have arisen there. The more heat, pressure and/or time employed for adhesive bonding, the more firmly does the bonding of the two materials to be adhesively bonded generally occur. Here, maximum bond strengths can normally be realized under processing conditions which are readily achieved in industry.

For the present purposes, thermoplastics are compounds as are defined in Rompp (Online version; 2008 edition, document designation RD-20-01271).

### b) Reactive Heat-Activable Adhesive Compositions

This term refers to polymer systems which have functional groups of such a type that a chemical reaction takes place on supply of heat, with the adhesive composition setting chemically and thus bringing about the adhesive effect. Reactive heat-activable adhesive compositions are generally not self-adhesive when heat is supplied, so that the adhesive effect occurs only after setting. Reactive heat-activable adhesive compositions are frequently not thermoplastic but are obtained by means of an elastomer-reactive resin system (however, compare the heat-activable films by means of thermoplastic reactive materials; see above).

The glass transition temperature is not of any significance for the function of reactive systems.

Adhesive compositions are basically made up of one or more polymers (the base polymer component, referred to as base polymer for the purpose of simplicity), with further components (for example resins (tack-inducing resins and/or reactive resins), plasticizers and the like) generally being mixed in to adjust the properties and further additives which have a favorable influence on the properties of the adhesive composition optionally being able to be added.

Reactive heat-activable films have a high dimensional stability when the elastomer component has a high elasticity. Furthermore, the reactive resins mean that a crosslinking reaction which significantly increases the adhesive bond strength can occur. Thus, for example, heat-activable films based on nitrile rubbers and phenolic resins, as are, for example, commercially available as the product 8475 from tesa, can be used for this adhesive bonding. A disadvantage of these reactive heat-activable films is, however, the dependence of the adhesive bond strength on the curing conditions. Here, particularly demanding requirements have to be met since electronic consumer goods are produced in enormous numbers and the individual components are thus produced in very short cycle times.

Due to its high viscosity, the nitrile rubber gives the heat-activable film a high dimensional stability and makes high adhesive forces on metals and plastics possible as a result of the crosslinking reaction.

Thermoplastic heat-activable films have likewise been known for a long time and are based, for example, on polyesters or copolyamides. Commercial examples are obtainable from the companies 3M (for example products 615, 615S) or tesa (for example product Tesa® 8462, 8444, 8466, 8468). However, for use in portable electronic consumer articles, these thermoplastic heat-activable films also have disadvantages compared to the reactive heat-activable films. This concerns, in particular, the “oozing behavior” when pressure is applied at elevated temperature, since mainly stamped shapes are processed in use and these then lose their shape.

However, there are also advantages such as the lower pressure and temperature required during the hot pressing step compared to the nitrile rubber-based reactive systems.

It has hitherto not been found possible to successfully produce a heat-activable film in a covering black color of the adhesive composition used in such a form that the property profile compared directly to the uncolored adhesive composition is retained and the adhesive film properties have the same property profiles.

In view of this prior art, it is an object of the invention to provide a heat-activable adhesive composition for fastening metal parts onto plastics for portable electronic consumer articles, with the respective adhesive composition having a covering black color and the property profile compared directly to the uncolored adhesive composition being retained and the adhesive film products having the same property profiles.

### SUMMARY OF THE INVENTION

According to the invention, the object is achieved by an adhesive film comprising at least one heat-activable adhesive composition to which black pigments have been added.

### DETAILED DESCRIPTION

Suitable black pigments are, for example, carbon black, organic azo dyes and/or chromium complexes. Examples of black pigments based on chromium complexes are [1-[(2-hydroxy-4-nitrophenyl)azo]-2-naphthalenolato(2)-)][[1-[(2-hydroxy-5-nitrophenyl)azo]-2-naphthalenolato(2-)]chromate(1-), bis[1-[(2-hydroxy-4-nitrophenyl)azo]-2-naphthalenolato(2-)]chromate(1-) and bis[1-[(2-hydroxy-5-nitrophenyl)azo]-2-naphthalenolato(2)-]chromate(1-).

Black pigments are preferably used in such amounts that the proportion of black pigments makes up not more than 8% by volume of the colored heat-activable adhesive composition. The adhesive properties of the adhesive composition can be retained in this way, but it was not expected that these amounts would lead to complete black coloration of the adhesive composition. However, this did occur. In actual fact, it was found that even proportions of as little as 0.9% by volume of black pigment, based on the colored adhesive composition, lead to good coloring. Particularly well-balanced, in terms of black coloration and adhesive properties, heat-activable adhesive compositions are obtained when black pigments are added in amounts of from 1.3 to 1.8% by volume to the colored adhesive composition.

If carbon black particles are added as black pigments, these are preferably used in amount of up to 12% by weight, based on the colored adhesive composition (i.e. the adhesive composition blended with color pigments). To achieve excellent coloring, it is advantageous to use carbon black in an amount of at least 1.2% by weight. In the case of use of carbon black as black pigment, it is very particularly preferably used in such an amount that the resulting colored heat-activable adhesive composition contains a proportion by weight of from 2.1 to 3.1% by weight of carbon black. For example, an amount of 2.4% by weight of carbon black in the colored heat-activable adhesive composition has been found to be very advantageous.

Carbon black can, for example, be added to the heat-activable composition in such a way that it is present as pigment preparation in a resin matrix which is chemically similar to the heat-activable adhesive composition or at least compatible with the latter (soluble therein), so that the resin matrix of the pigment preparation has to be added to the adhesive composition matrix of the ultimately colored heat-activable adhesive composition. The amounts to be added should then preferably be adapted so that the amount of carbon black in the adhesive composition corresponds to the above-described proportions.

As heat-activable adhesive compositions suitable for the purposes of the invention, it is possible to use both reactive heat-activable adhesive compositions and thermoplastic heat-activable adhesive compositions. Very particular preference is given to using reactive systems.

As reactive heat-activable adhesive compositions, preference is given to using those based on a mixture of at least one nitrile rubber S1 and a reactive component, in particular a reactive resin.

The proportion by weight of the nitrile rubber S1 is preferably in the range from 25 to 70% by weight, particularly preferably from 30 to 60%, of the total composition of the reactive heat-activable film.

The nitrile rubbers S1 preferably have an acrylonitrile content of from 15 to 45%. A further criterion for the nitrile rubber S1 is the Mooney viscosity. Since a high flexibility at low temperatures has to be ensured, the Mooney viscosity should preferably be below 100 (Mooney ML 1+4 at 100° C.; in accordance with DIN 53523). Commercial examples of such nitrile rubbers are Nipol™ N917 from Zeon Chemicals.

For the purposes of the invention, reactive resins are, in particular, short- to medium-chain oligomers or polymeric compounds, in particular ones having average molecular weights in the range up to 10 000 g/mol. The proportion of the reactive resins in the heat-activable adhesive is preferably in the range from 75 to 30% by weight. A very preferred group comprises epoxy resins. The weight average molecular weight M_{w} of the epoxy resins varies from 100 g/mol up to a maximum of 10 000 g/mol for polymeric epoxy resins.

The epoxy resins comprise, for example, the reaction product of bisphenol A and epichlorohydrin, epichlorohydrin, glycidyl esters, the reaction product of epichlorohydrin and p-aminophenol.

Preferred commercial examples are Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical and HPT™ 1071, HPT™ 1079 likewise from Shell Chemical.

Examples of commercial aliphatic epoxy resins are vinylcyclohexane dioxides such as ERL-4206, ERL-4221, ERL 4201, ERL-4289 or ERL-0400 from Union Carbide Corp.

As novolak resins, it is possible to use, for example, Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DiaNipon Ink Chemistry or Epicote™ 152 from Shell Chemical.

Furthermore, it is also possible to use melamine resins such as Cymel™ 327 and 323 from Cytec as reactive resins.

Phenolic resins are particularly preferably used as reactive resins. Highly suitable resins of this type are, for example, novolak resins, phenolic resol resins or combinations of novolak resins and phenolic resins. Examples of commercially available phenolic resins are YP 50 from Toto Kasei, PKHC from Union Carbide Corp. and BKR 2620 from Showa Union Gosei Corp.

Furthermore, it is also possible to use terpene phenolic resins such as NIREZ™ 2019 from Arizona Chemical as reactive resins.

Furthermore, polyisocyanates such as Coronate™ L from Nippon Polyurethane Ind., Desmodur™ N3300 or Mondur™ 489 from Bayer.

In an advantageous embodiment of the adhesive film of the invention, adhesive force-increasing (tack-inducing) resins are also added to the blend; very advantageously in a proportion of up to 30% by weight, based on the total mixture of the heat-activable adhesive. As tack-inducing resins to be added, it is possible to use all, without exception, previously known adhesive resins described in the literature. Mention may be made by way of example of pinene, indene and rosin resins, their disproportionated, hydrogenated, polymerized, esterified derivatives and salts, aliphatic and aromatic hydrocarbon resins, terpene resins and terpene phenolic resins such as C5-, C9- and other hydrocarbon resins. Any combinations of these and further resins can be used in order to adjust the properties of the resulting adhesive composition in a desired way. In general, it is possible to use all resins which are compatible with (soluble in) the rubbers S1; particular reference may be made to all aliphatic, aromatic, alkylaromatic hydrocarbon resins, hydrocarbon resins based on pure monomers, hydrogenated hydrocarbon resins, functionalized hydrocarbon resins and also natural resins. Explicit reference may be made to the presentation of the state of knowledge in “Handbook of Pressure Sensitive Adhesive Technology” by Donatas Satas (van Nostrand, 1989).

In order to accelerate the reaction between the two components, crosslinkers and accelerators can optionally also be added to the mixture.

Suitable accelerators are, for example, imidazoles commercially available under the names 2M7, 2E4MN, 2PZ-CN, 2PZ-CNS, P0505, L07N from Shikoku Chem. Corp. or Curezol 2MZ from Air Products. Furthermore, additions of HMTA (hexamethylenetetramine) are also suitable as crosslinker.

Furthermore, amines, in particular tertiary amines, can also be used as accelerators.

Apart from reactive resins, plasticizers can also be used. In a preferred embodiment of the invention, it is possible to use plasticizers based on polyglycol ethers, polyethylene oxides, phosphate esters, aliphatic carboxylic esters and benzoic esters. Furthermore, aromatic carboxylic esters, higher molecular weight diols, sulfonamides and adipic esters can also be used.

In a further preferred embodiment, further additives such as polyvinyl formal, polyacrylate rubbers, chloroprene rubbers, ethylene-propylene diene rubbers, methyl-vinyl-silicone rubbers, fluorosilicone rubbers, tetrafluoroethylene-propylene copolymer rubbers, butyl rubbers, styrene-butadiene rubbers are added to the blend.

Polyvinyl butryals are obtainable under the name Butvar™ from Solutia, the name Pioloform™ from Wacker and the name Mowital™ from Kuraray. Polyacrylate rubbers are obtainable under the name Nipol AR™ from Zeon. Chloroprene rubbers are obtainable under the name Baypren™ from Bayer. Ethylene-propylene-diene rubbers are obtainable under the name Keltan™ from DSM, the name Vistalon™ from ExxonMobil and the name Buna EP™ from Bayer. Methyl-vinyl-silicone rubbers are obtainable under the name Silastic™ from Dow Corning and the name Silopren™ from GE Silicones. Fluorosilicone rubbers are obtainable under the name Silastic™ from GE Silicones. Butyl rubbers are obtainable under the name Esso Butyl™ from ExxonMobil. Styrene-butadiene rubbers are obtainable under the name Buna S™ from Bayer and Europrene™ from Eni Chem and the name Polysar S™ from Bayer.

Polyvinyl formals are obtainable under the name Formvar™ from Ladd Research.

In a further embodiment, thermoplastic polymers, preferably ones having a softening point of greater than 85° C. and less than 150° C. can be used as heat-activable adhesive composition according to the invention.

Suitable thermoplastics are, for example, polyesters or copolyesters, polyamides or copolyamides, thermoplastic polyurethanes, polyolefins such as polyethylene (Hostalen®, Hostalen Polyethylene GmbH), polypropylene (Vestolen P®, DSM). The listing makes no claim of completeness. Furthermore, blends of various thermoplastics can also be used, as can two different thermoplastics (e.g. double-sided coating or different coating on the two sides of a support nonwoven).

### Adhesive Film Structures

In a preferred use form, the colored heat-activable adhesive compositions are offered in layer form, i.e. in the form of a heat-activable adhesive film. Such adhesive films can be in single-layer form (known as transfer adhesive films) or have a support so that a support-containing single- or double-sided adhesive film results.

Particular preference is given to using single-layer or three-layer heat-activable adhesive films, so that the total thickness of the adhesive film is, depending on surface roughness, curvature or size of the substrate on which adhesive bonding is intended, in the range from 25 to 750 μm, particularly preferably in the range from 30 to 250 μm. Such adhesive films are, for example, highly suitable for adhesive bonding of metal parts onto plastics, of metals onto metals and of plastics onto plastics. The plastics should preferably be selected so that they withstand the heating necessary to activate the heat-activable, bondable adhesive film without suffering damage.

In a preferred variant, the adhesive tape of the invention consists of a support film layer, preferably of PET, and a black-colored heat-activable adhesive composition layer on each side of the support film. It has surprisingly been found that a support-containing product makes it possible to avoid the formation of scratches on sensitive substrate surfaces during the hot pressing step, while this problem was observed in the case of corresponding transfer adhesive films. The presence of a support film in the heat-activable adhesive film thus additionally serves the purpose of a protective function in respect of the substrates to be adhesively bonded.

The adhesive tape can very advantageously have a symmetric structure (identical adhesive layer thicknesses and/or chemical compositions of the adhesive composition and/or adhesive composition colorings on the two sides of the support film), but the adhesive layers of the support-containing heat-activable adhesive film of the invention can also be selected independently of one another in respect of their adhesive layer thicknesses and/or chemical compositions of their adhesive composition and/or adhesive composition colorings.

The black adhesive composition layers in each case preferably have a thickness of from 5 μm to 250 μm. Layer thicknesses of 30 μm, 50 μm, 60 μm; 100 μm; 125 μm; 150 μm, 200 μm and 250 μm are very preferably realized. The support-containing adhesive films can, as indicated above, have a symmetric structure, but the layer thicknesses of the two adhesive composition layers can also be combined independently of one another; with one of the abovementioned layer thicknesses particularly preferably being selected in each case.

The support film preferably has a thickness of from 5 to 250 μm, more preferably from 8 to 50 μm, very preferably from 12 to 36 μm and very particularly preferably 23 μm. 23 μm thick PET films have the advantage that they allow very good adhesive properties of the double-sided adhesive tape since the film is very flexible and can readily adapt to the surface roughnesses of the substrates to be adhesively bonded.

Suitable support materials are the customary materials with which a person skilled in the art will be familiar, for example films (polyester, polyethylene terephthalate (PET), polyethylene (PE) such as low molecular weight polyethylene (HDPE) or high molecular weight polyethylene (LDPE), polypropylene (PP), biaxially oriented polypropylene (BOPP), polyvinyl chloride (PVC), polyimide), nonwovens, foams, woven fabrics and woven films and also release paper (glassine). In a particularly preferred embodiment, a double-sidedly heat-activable bondable product according to the invention consists of a polyethylene terephthalate support film and in each case a black-colored heat-activable adhesive film, preferably on the basis of a reactive system based on phenolic resin/nitrile rubber, on the two sides of the support film. Preference is given to using heat-activable adhesive films as have been described above in this text.

The support films can be free of stress or have one or more preferential directions. Preferential directions are achieved by stretching in one or two directions. For the production of, for example, PET films, it is possible to use antiblocking agents such as silicon dioxide, siliceous chalk or chalk, zeolites. The support film itself can be transparent or semitransparent or even have a low light transmittance, for example as a result of coloring, especially black coloring. This can be achieved, for example, by mixing color pigments into the film material. Thus, for example, carbon blacks are particularly suitable for introducing a black color. However, the pigments or particles should always have a diameter smaller than the final thickness of the support film. Optimal coloring can be achieved using from 5 to 40% by weight of particles, based on the film material.

The films can also be corrosively treated (e.g. trichloroacetic acid or trifluoroacetic acid), be pretreated by means of corona or plasma or be provided with a primer (e.g. Saran).

To produce the adhesive films of the invention, the adhesive compositions are preferably firstly colored black and formed into an adhesive film (adhesive composition layer), in particular using temporary support materials (release liners). The heat-activable adhesive films which have been colored with a covering black color are then preferably continuously laminated onto, for example, a 23 μm PET film by means of heated rollers at a) 115° C.-135° C. and b) 140° C.-185° C. at v=10 m/min.

The softening point quoted for polymeric compounds is determined by the ring-and-ball method in accordance with DIN EN 1427: 2007 (examination of the polymeric sampling instead of bitumen using otherwise the same method). The measurements are carried out in a glycerol bath. The softening point figures reported are the results of this measurement.

The determination of the average molecular weight MW and the polydispersity PD was carried out by means of gel permeation chromatography (GPC). THF containing 0.1% by volume of trifluoroacetic acid was used as eluent. The measurement was carried out at 25° C. As preliminary column, use was made of PSS-SDV, 5 μm, 103 Å (10-7 m), ID 8.0 mm×50 mm. For the fractionation, the columns PSS-SDV, 5 μm, 103 Å (10-7 m), 105 Å (10-5 m) and 106 Å (10-4 m), in each case ID 8.0 mm×300 mm, were used. The sample concentration was 4 g/l, and the flow rate was 1.0 ml per minute. Measurements were carried out against PMMA standards.

### EXAMPLES

A pigment preparation composed of 40% by weight of carbon black in a phenolic resin matrix was prepared.

### Reference Example 1

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The heat-activable adhesive composition was subsequently spread as solution onto a glassine release paper and dried at 100° C. for 10 minutes. After drying, the layer thickness was 30 μm.

### Reference Example 2

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The heat-activable adhesive composition was subsequently spread as solution onto a glassine release paper and dried at 100° C. for 10 minutes. After drying, the layer thickness was 100 μm. Two of these layers were subsequently laminated together at 100° C. on a roll laminator. The layer thickness was subsequently 200 μm.

### Example 1

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The pigment preparation was subsequently stirred in by means of a blade stirrer so that the proportion of carbon black in the adhesive composition was 2.4% by weight. The heat-activable adhesive composition was subsequently spread as solution onto a glassine release paper and dried at 100° C. for 10 minutes. After drying, the layer thickness was 30 μm.

### Example 2

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The pigment preparation was subsequently stirred in by means of a blade stirrer so that the proportion of carbon black in the adhesive composition was 8% by weight. The heat-activable adhesive composition was subsequently spread as solution onto a glassine release paper and dried at 100° C. for 10 minutes. After drying, the layer thickness was 30 μm.

### Example 3

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The pigment preparation was subsequently stirred in by means of a blade stirrer so that the proportion of carbon black in the adhesive composition was 2.4% by weight. The heat-activable adhesive composition was subsequently spread as solution onto a glassine release paper and dried at 100° C. for 10 minutes. After drying, the layer thickness was 100 μm. Two of these layers were subsequently laminated together at 100° C. on a roll laminator. The layer thickness was subsequently 200 μm.

### Example 4

50% by weight of Breon N41H80GR (nitrile rubber) from Zeon, 40% by weight of phenol novolak resin Durez 33040 blended with 8% of HMTA (Rohm and Haas) and 10% by weight of the phenolic resol resin 9610 LW from Bakelite were produced as 30% strength solution in methyl ethyl ketone in a kneader. The kneading time was 20 hours. The pigment preparation was subsequently stirred in by means of a blade stirrer so that the proportion of carbon black in the adhesive composition was 8% by weight. The heat-activable adhesive composition was subsequently spread as solution onto a glassine release paper and dried at 100° C. for 10 minutes. After drying, the layer thickness was 100 μm. Two of these layers were subsequently laminated together at 100° C. on a roll laminator. The layer thickness was subsequently 200 μm.

### Reference Example 3

Grilltex™ 1442 E from EMS-Grilltech (thermoplastic polymer based on copolyester; melting range of the polymer according to the manufacturer's information from 93° C. to 121° C.) was pressed to 100 μm between two layers of siliconized glassine release paper at 140° C. in a hot press.

### Reference Example 4

Grilltex™ 1442 E from EMS-Grilltech was pressed onto both sides of a paper nonwoven having a weight per unit area of 13 g/m² between two layers of siliconized glassine release paper at 150° C. in a hot press. The layer thickness of the double-sided adhesive tape without glassine release paper was 150 μm. The penetration depth of the adhesive composition into the nonwoven was determined from both sides by means of scanning electron micrographs. Here, the average layer thickness of the support nonwoven into which the hot melt adhesive had not penetrated was determined. This value is divided by the initial layer thickness of the support nonwoven and then reported in percent. In this example, an average degree of impregnation of 100% was found, i.e. 100% of the sample had been penetrated by the hot melt adhesive.

### Example 5

Grilltex™ 1442 E from EMS-Grilltech was coextruded with the pigment preparation in such a way that the proportion of carbon black in the adhesive composition was then 2.4% by weight. The colored adhesive composition was pressed to 150 μm between two layers of siliconized glassine release paper at 140° C. in a hot press.

### Example 6

Grilltex™ 1442 E from EMS-Grilltech was coextruded with the pigment preparation in such a way that the proportion of carbon black in the adhesive composition was then 8% by weight. The colored adhesive composition was pressed to 150 μm between two layers of siliconized glassine release paper at 140° C. in a hot press.

### Example 7

Grilltex™ 1442 E from EMS-Grilltech was coextruded with the pigment preparation in such a way that the proportion of carbon black in the adhesive composition was then 2.4% by weight and the colored adhesive composition was pressed onto both sides of a paper nonwoven having a weight per unit area of 13 g/m² between two layers of siliconized glassine release paper at 150° C. in a hot press. The layer thickness of the double-sided adhesive tape without glassine release paper was 150 μm. The penetration depth was determined from both sides by means of scanning electron micrographs. Here, the average layer thickness of the support nonwoven into which the hot melt adhesive had not penetrated was determined. This value is divided by the initial layer thickness of the support nonwoven and then reported in percent. In this example, an average degree of impregnation of 100% was found, i.e. 100% of the sample had been penetrated by the hot melt adhesive.

### Example 8

Grilltex™ 1442 E from EMS-Grilltech was coextruded with the pigment preparation in such a way that the proportion of carbon black in the adhesive composition was then 8% by weight and the colored adhesive composition was pressed onto both sides of a paper nonwoven having a weight per unit area of 13 g/m² between two layers of siliconized glassine release paper at 150° C. in a hot press. The layer thickness of the double-sided adhesive tape without glassine release paper was 150 μm. The penetration depth was determined from both sides by means of scanning electron micrographs. Here, the average layer thickness of the support nonwoven into which the hot melt adhesive had not penetrated was determined. This value is divided by the initial layer thickness of the support nonwoven and then reported in percent. In this example, an average degree of impregnation of 100% was found, i.e. 100% of the sample had been penetrated by the hot melt adhesive.

The adhesive bond strength of the adhesive films provided as described above is determined by means of a dynamic shear test using test specimens.

To produce the test specimens, two substrate plates were adhesively bonded by means of the adhesive film to be examined. One of the substrate plates is a 1.5 mm thick aluminum plate having a size of 2 cm×10 cm; the other substrate plate is a 3 mm thick polycarbonate plate likewise having dimensions of 2 cm×10 cm.

The adhesive film samples based on phenolic resin/nitrile rubber are laminated via their free side onto the aluminum plate, using a heating plate having a temperature of 95° C. for activation. The release film is subsequently peeled off. Adhesive bonding of this composite on the polycarbonate plate is carried out in a heating press, with heating being carried out via the aluminum side. Heat activation is carried out using a hot press punch having a temperature of 180° C. at a pressure of 10 bar and a pressing time of 7 s.

The adhesive film samples based on thermoplastic heat-activable adhesive composition are laminated by their free side onto the aluminum using a heating plate having a temperature of 120° C. The release film is subsequently peeled off. Adhesive bonding of this composite on the polycarbonate plate is carried out in a heating press, with heating being carried out via the aluminum side. Heat activation is carried out using a hot press punch having a temperature of 150° C. at a pressure of 6 bar and a pressing time of 7 s.

The test specimens are subsequently torn apart on a Zwick machine at 10 mm/min using the slowly increasing force F. The measured value is recorded in N/mm² and is the maximum force (Fmax) which is measured in order to separate the test specimens (aluminum and polycarbonate) from one another. The measurement is carried out at room temperature (23° C.) and 50% relative atmospheric humidity.

The measurements are carried out immediately after pressing and heat activation, waiting about 30 minutes for acclimatization to the respective temperature range.

### Results:

The heat-activable adhesive films 1 to 8 according to the invention were tested using a method analogous to reference examples 1-4. Reference examples 1-2 are heat-activable films based on pigment-free heat-activable adhesives. Reference examples 3 and 4 are heat-activable films based on pigment-free thermoplastic adhesives.

All examples were used under identical curing conditions for adhesively bonding aluminum onto polycarbonate (PC)—a use which frequently occurs, for example, in the production of cell phones. After adhesive bonding, the adhesive bond strengths were measured. The adhesive bonding/curing conditions were kept constant for

a) reactive heat-activable films
and
b) thermoplastic heat-activable films.

The results are shown in table 1.

TABLE 1

| Examples | Fmax |
|---|---|
| Reference 1 | 6.5 N/mm² |
| Reference 2 | 7.8 N/mm² |
| Reference 3 | 5.8 N/mm² |
| Reference 4 | 4.2 N/mm² |
| 1 | 6.6 N/mm² |
| 2 | 5.3 N/mm² |
| 3 | 7.8 N/mm² |
| 4 | 5.9 N/mm² |
| 5 | 5.9 N/mm² |
| 6 | 4.6 N/mm² |
| 7 | 4.2 N/mm² |
| 8 | 3.4 N/mm² |

It can be seen from table 1 that completely covering coloration could be achieved without the adhesive bonding properties being impaired in the case of, in particular, an amount of pigment (carbon black) of 2.4% by weight in the adhesive composition, while still satisfactory but noticeably poorer adhesive bond strengths of the adhesive films are found at an amount of 8% by weight in the heat-activable adhesive composition.

Samples of the above-described test specimens were additionally subjected to the following program in an air conditioned chamber: CCT=“climatic change test”; heating to +85° C./85% Rel. h.; then 27 cycles in the range from +85° C./85% Rel. h. to −40° C. and subsequent re-heating to 85° C./85%; each complete cycle (85° C.→−40° C.→85° C.) took one hour.

After the above-described procedure, the adhesive bond strengths of the test specimens were subsequently tested again. The values displayed by the samples having a proportion of pigment of 2.4% by weight in the adhesive composition remained unchanged after climatic change treatment, as shown in the following table for the example of the 30 μm adhesive film containing pigment preparation (“black”) and without pigment preparation (“nb”).

| Sample | Fmax |
|---|---|
| 30μ nb | 6.5 N/mm² |
| 30μ black | 6.6 N/mm² |
| 30μ nb CCT | 3.2 N/mm² |
| 30μ black CCT | 3.2 N/mm² |

As further studies have shown, the surface resistance and the thermophysical properties likewise remain unchanged after climatic change treatment in the case of the samples having a pigment content of 2.4% by weight of carbon black in the adhesive composition.

The degree of blackening of the colored heat-activable adhesive compositions was examined using a measurement in accordance with EN ISO 11664-4. Here, values in the following ranges

### L: ≦30

a: <2 and >−2
b: <2 and >−2
were achieved for all examples according to the invention and excellent covering black colorations are thus achieved.

1. An adhesive film comprising at least one support film and two exterior adhesive composition layers, wherein at least one of the adhesive compositions of the exterior adhesive composition layers is a heat-activable adhesively bondable adhesive composition having black pigments mixed into the heat-activable adhesive composition.

2. The adhesive film as claimed in claim 1, wherein the adhesive compositions of both exterior adhesive composition layers are black-colored heat-activated adhesively bondable adhesive compositions.

3. The adhesive film of claim 1, wherein one or both of the adhesive compositions of the exterior adhesive composition layers are formed of at least one nitrile rubber and at least one phenolic resin.

4. The adhesive film of claim 1, wherein that the black pigments are present in the colored adhesive composition in a proportion of from 0.9 to 8% by volume, based on the colored adhesive composition.

5. The adhesive film of claim 4, wherein the black pigments are present in the colored adhesive composition in a proportion of from 1.3 to 1.8% by volume, based on the colored adhesive composition.

6. The adhesive film of claim 1, wherein the support film is formed of polyethylene terephthalate.

7. The adhesive film of claim 1, wherein no further layers apart from optional covering layers for the exterior adhesive compositions are present in the adhesive film structure.

8. The adhesive film of claim 1, having a total thickness in the range from 25 to 750 μm.
